(19) United States
(12) Patent Application Publication
(10) Pub. No.: US 2003/0093604 A1
(43) Pub. Date: May 15, 2003

(54) Method of error isolation for shared PCI slots

(76) Inventor: Terry Ping-Chung Lee, Antelope, CA (US)

Correspondence Address: HEWLETT-PACKARD COMPANY, Intellectual Property Administration, P.O. Box 272400, Fort Collins, CO, 80527-2400, US

(21) Appl. No.: 09/991,453

(22) Filed: Nov. 14, 2001

(51) Int. Cl. G06F 13/00

(52) U.S. Cl. 710/302

(57) ABSTRACT

A method of identifying a failing PCI slot In a computer having a peripheral component interconnect (PCI) system having a host bridge coupling a plurality of PCI slots of a PCI bus to a processor where the computer uses firmware to access the base address registers. A firmware maintained PCI resource allocation map is created which addresses for PCI slots associated with base address registers and sizes of address ranges for these addresses are mapped. The firmware maintained PCI resource allocation map is updated upon the occurrence of at least of firmware being called to execute at least one of a hot plug operation and a PCI configuration space transaction. Upon the host bridge logging an error address due to a failing PCI slot, the failing PCI slot is identified from the information in the firmware maintained PCI resource allocation map.

### FIELD OF THE INVENTION

This invention relates to peripheral component interconnect (“PCI”) systems in computers, and more particularly, to a method of error isolation for shared PCI slots.

### BACKGROUND OF THE INVENTION

Most if not virtually all personal computers today utilize the PCI local bus system. FIG. 6 shows a typical block diagram of a PCI system 200. In PCI system 200, a processor/cache/memory subsystem 202 is connected to a PCI local bus 204 through PCI host bridge 203. PCI host bridge 203 provides a low latency path through which the processor of processor/cache/memory subsystem 202 can directly access PCI devices 206 mapped anywhere in the memory or I/O address spaces and also provides a high bandwidth path allowing PCI masters direct access to main memory. PCI devices 206 can include audio cards, motion video cards, graphics cards, SCSI controllers, LAN cards and expansion bus interface cards. PCI local bus 204 includes PCI slots 208 in which these cards are received.

This typical configuration of a PCI system shown in FIG. 6 is a multi-slot PCI host bridge configuration where multiple PCI slots 208 are below the host bridge 203. Host bridge 203 is typically implemented on a chip, which may also include a memory controller. Some computers also have a PCI to PCI bridge 210 (shown in phantom in FIG. 6) which is a circuit (typically implemented on a chip) that connects one PCI local bus, such as PCI local bus 204, to a second PCI local bus, such as PCI local bus 212 (shown in phantom in FIG. 6). Second PCI local bus 212 also includes PCI slots 208 in which interface cards for PCI devices 206 are received.

As is known, in a computer having multiple PCI slots, addresses are somewhat arbitrarily assigned to the PCI slots when the computer is powered-up. Also as is known, power-up software must build a consistent address map before booting the computer to an operating system. Thus, it must determine how much memory is in the system and how much address space the I/O controllers in the system require. This map, called a PCI resource allocation map, is a map of addresses that shows what addresses were assigned to the interface cards or I/O controllers in PCI slots during power-up. Once this is done, the power-up software can map the I/O controllers into reasonable locations and proceed with system boot.

To do this mapping in a device independent manner, the base registers, called base address registers or BARs, are placed in a predefined header portion of the configuration register space in PCI compliant computers. BARs that map into memory space can be 32 bits or 64 bits wide while BARs that map into I/O space are always 32 bits wide. The number of upper bits that a device actually implements depends on how much address space to which the device responds. For example, a device that wants a 1 MB memory address space (using a 32 bit BAR) would build the top 12 bits of the address register, hardwiring the other bits to zero. By writing all 1's to a BAR associated with a device, the address space the device requires can be determined. The device will return 0's in all don't-care address bits (the lower address bits that have been hardwired to zero), and the size can thus be determined from the address bits returning zero. This is explained in more detail in Chapter 6 of the PCI Local Bus Specification, Revision 2.2, published by the PCI Special Interest Group, 2575 N. E. Kathryn #17, Hillsboro, Oreg. 97124.

When a failure occurs in a PCI slot, the address at which the failure occurred is logged. This is typically accomplished by error logging circuitry in the host bridge (or PCI to PCI bridge). However, when multiple PCI slots (or devices) are present below a PCI host bridge (or PCI to PCI bridge), the firmware (in computers whose operating systems use firmware to write to BARs) cannot determine the failing PCI slot or device because it lacks sufficient information to map the failure address to the corresponding PCI device. While the firmware may have the information contained in the initial PCI resource allocation map, the PCI resource allocation map may have been changed by the computer's operating system, such as by the operating system changing the BAR values or updating the PCI resource allocation map in the event of a PCI configuration space transaction or hot plug operation. A PCI configuration space transaction determines what PCI slots have interface cards in them, what type of interface cards they are and assigns addresses to the cards. A hot plug operation allows interface cards to be added and removed to the PCI slots while the computer is on.

It is an object of this invention to provide a method of identifying a failing PCI slot in a multiple PCI slot host bridge configuration in computers that use firmware to access the BARs. In this regard, it should be understood that not all computers utilize firmware to access BARs. In some computers, such as computers using IA-32 operating systems, the operating system directly accesses the BARs as opposed to using firmware to access the BARs.

### SUMMARY OF THE INVENTION

In a method according to the invention, a computer uses firmware to access BARs Firmware maintains a PCI resource allocation map, preferably a separate PCI resource allocation map from the PCI resource allocation map created during system power-up, and updates it each time the operating system executes firmware to perform PCI configuration space transactions or PCI hot plug operations. When a PCI error occurs and a PCI host bridge (or PCI to PCI bridge) logs the failing address, the firmware then uses this firmware maintained PCI resource allocation map to determine which PCI slot, and therefore which PCI device, corresponds to the failure.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings wherein:

FIG. 1 is a flow chart of a routine for creating and updating a firmware maintained PCI resource allocation map in accordance with the invention;

FIG. 2 is a flow chart of set hot plug flag routine in accordance with the invention;

FIG. 3 is a flow chart of a routine that invalidates map entries of the firmware maintained PCI resource allocation map for slots with hot plug flags set upon a PCI configuration space transaction in accordance with the invention;

FIG. 4 is a flow chart of a routine that invalidates map entries of the firmware maintained PCI resource allocation map for slots with hot plug flags set upon the host bridge logging an error address;

FIG. 5 is a more detailed flow chart of the PCI failing slot determination step of FIG. 4; and

FIG. 6 is a block diagram of a prior art PCI system.

### DETAILED DESCRIPTION

A method according to the invention identifies a failing PCI slot in a computer having a multi-slot PCI host bridge configuration in which the computer's operating system uses firmware to access the BARs. It also identifies a failing PCI slot in those computers that also have a PCI to PCI bridge. As is known, the PCI host bridge (and PCI to PCI bridge if present) contains error logging circuitry that identifies the address associated with a failed transaction. In accordance with the invention, the computer's operating system uses firmware services to execute PCI configuration space transactions and PCI hot plug operations.

The firmware maintains a PCI resource allocation map which is a map showing which addresses have been assigned to which PCI cards and the size of the address ranges of these addresses. The PCI resource allocation map is preferably a separate PCI resource allocation map from the initial PCI resource allocation map created during system power-up, although this separate PCI resource allocation map is also created during power-up. This separate PCI resource allocation map will be referred to herein as the firmware maintained PCI resource allocation map. Each time the computer's operating system executes firmware to perform PCI configuration space transactions or PCI hot plug operations, the firmware updates the firmware maintained PCI resource allocation map. When a PCI error occurs and a PCI host bridge (or PCI to PCI bridge) logs the failing address, the firmware then uses the firmware maintained PCI resource allocation map to determine which PCI slot, and therefore which PCI device or interface card, corresponds to the failure.

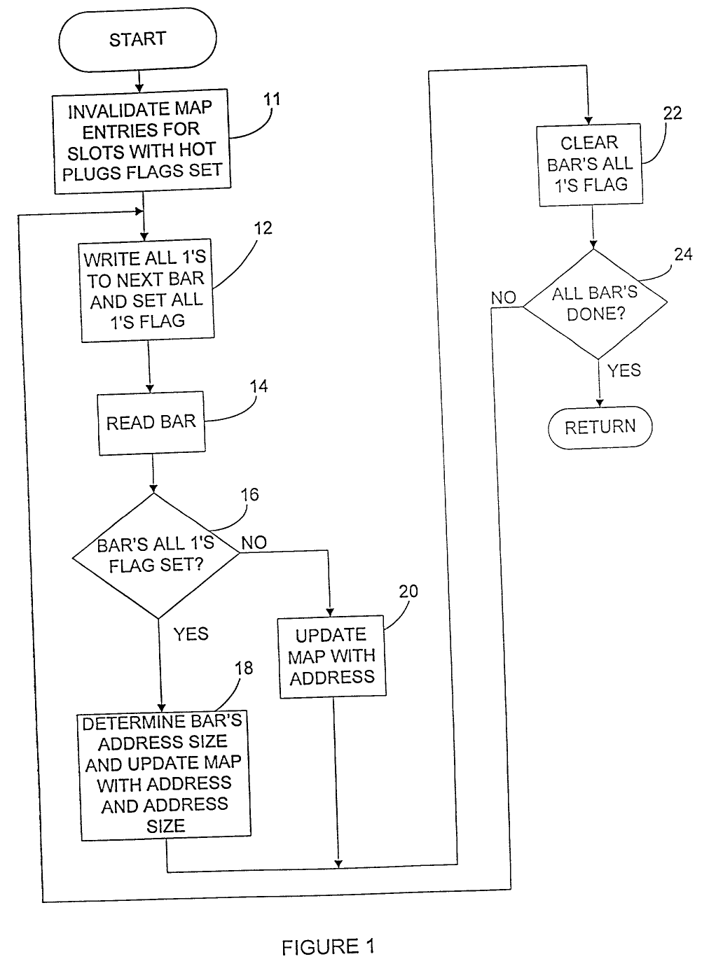

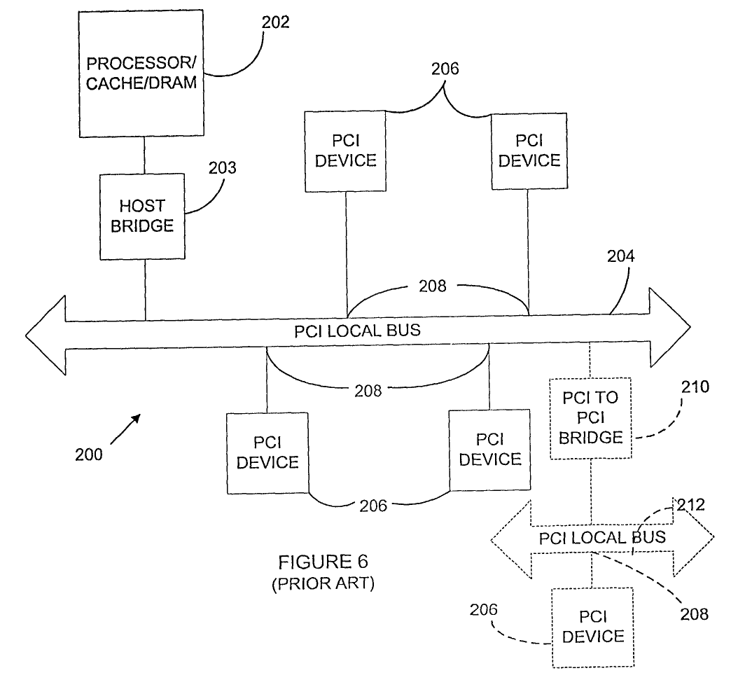

Turning to FIGS. 1 through 5, the method of the invention is described in more detail. FIG. 1 shows the routine that firmware executes on power-up to create the firmware maintained PCI resource allocation map. Firmware also executes this routine to update the PCI resource allocation map when it is called to execute a PCI configuration space transaction. At 10, all map entries for PCI slots 208 (FIG. 6) having their hot plug flags set are invalidated. At 12, all 1's are written to the next base address register (“BAR”) and an all 1's flag for that BAR is set. This BAR is read at 14 and at 16, the all 1's flag for that BAR is checked to see if it is set. If that BAR's all 1's flag is set, which it usually will be, the address size range for the address associated with that BAR's is determined from the value read back from the BAR in known fashion and the firmware maintained PCI resource allocation map is updated with the device address associated with that BAR and the determined address size range at 18. If that BAR's all 1's flag was not set, the PCI resource allocation map is updated with the device address associated with that BAR at 20. It should be understood that the address associated with that BAR is unlikely to be correct due to the all 1's write operation and is subsequently updated during the system power-up routine or PCI configuration space transaction with the correct address in known manner. The BAR's all 1's flag is to guard against the operating system writing to the BAR between step 12 and step 14 in that it is cleared when the operating system writes other than all 1's to the BAR. After the firmware maintained PCI resource allocation map has been updated, the BAR's all 1's flag is cleared at 22. At 24, a check is made to see if all BAR's have been processed. If not, steps 12 to 24 are repeated until they are.

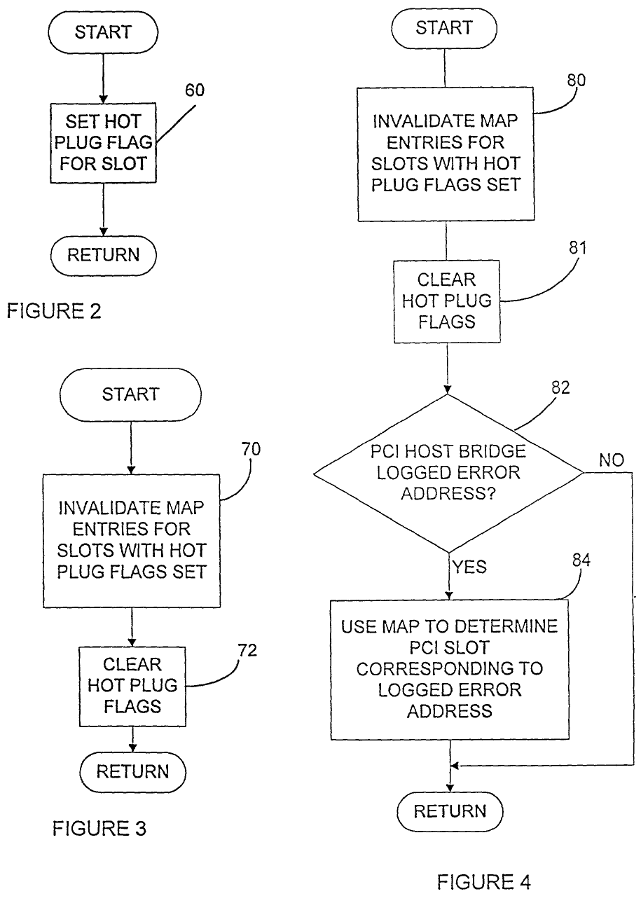

With reference to FIG. 2, when the operating system calls firmware to execute a hot plug operation, a hot plug flag for the PCI slot on which the hot plug operation is being executed is set at 60.

With reference to FIG. 3, when the operating system calls firmware to perform a PCI space configuration, all map entries in the firmware maintained PCI resource allocation map associated with PCI slots having their hot plug flag sets are invalidated at 70. At 72, the hot plug flags are cleared.

Turning to FIG. 4, the PCI error routine is described. When a PCI error occurs, firmware first invalidates at 80 all map entries in the firmware maintained PCI resource allocation map for PCI slots having their hot plug flags set. At 81, the hot plug flags are cleared. Firmware next checks at 82 to see if the host bridge, such as host bridge 202 in FIG. 6, logged an error address. If not, the PCI error routine returns and the PCI error is processed in known fashion. If the host bridge did log an error address, firmware uses the firmware maintained PCI resource allocation map to identify the failing PCI slot at 84. As used herein, “failing PCI slot” means that a PCI device has had some type of failure that causes the host bridge to log an error address.

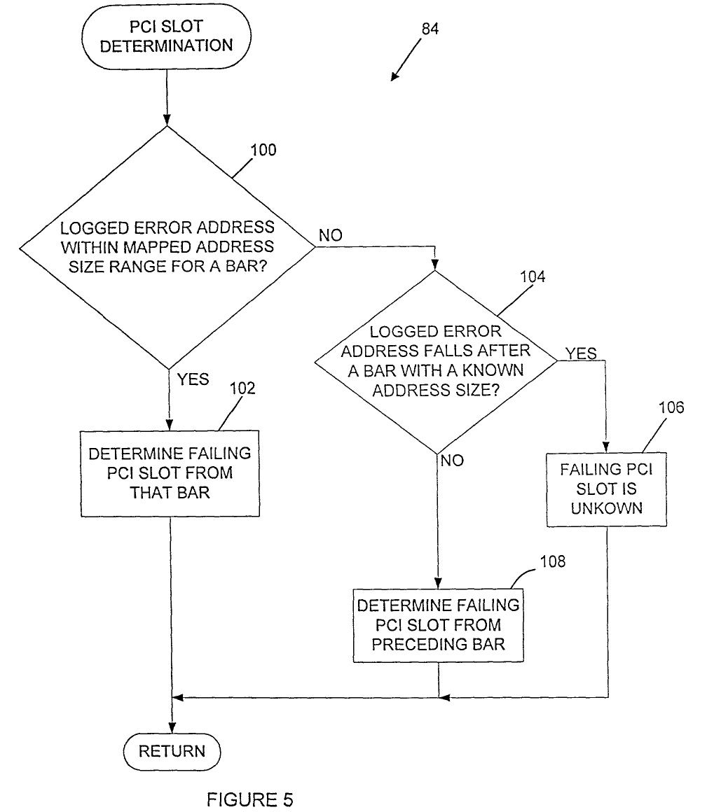

With reference to FIG. 5, the step of using the firmware maintained PCI resource allocation map to determine the failing PCI slot, such as a PCI slot 208, is described in more detail. At 100, a determination is made whether the logged error address falls within a known address size range for an address associated with a BAR. If so, the failing PCI slot is determined from the address associated with that BAR at 102. (The address associated with that BAR is determined from the PCI resource allocation map and indicates the device that generated the failure.) If not, the determination is then made at 104 whether the logged error address falls after a known address size range for an address associated with a BAR. If so, the failing PCI slot is determined to be unknown at 106. If not, the failing PCI slot is determined from the address associated with the BAR immediately preceding the logged error address at 108.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. In a computer having a peripheral component interconnect (PCI) system having a host bridge coupling a plurality of PCI slots of a PCI bus to a processor, the computer accessing base address registers with firmware, a method of identifying a failing PCI slot, comprising the steps of:
(a) creating a firmware maintained PCI resource allocation map in which addresses for PCI slots associated with the base address registers and sizes of address ranges for these addresses are mapped;
(b) updating the firmware maintained PCI resource allocation map upon the occurrence of at least of firmware being called to execute at least one of a hot plug operation and a PCI configuration space transaction; and
(c) upon the host bridge logging an error address due to a failing PCI slot, identifying the failing PCI slot from the information in the firmware maintained PCI resource allocation map.

2. The method of claim 1 wherein upon the occurrence of a hot plug operation for a PCI slot, a hot plug flag associated with that PCI slot is set and upon the host bridge logging an error address, invalidating the firmware maintained PCI resource allocation map entries associated with each PCI slot having its hot plug flag set.

3. The method of claim 2 and further including upon the occurrence of firmware being called to execute a PCI configuration space transaction, invalidating the firmware maintained PCI resource allocation map entries associated with each PCI slot having its associated hot plug flag set and clearing those hot plug flags.

4. The method of claim 1 wherein the step of identifying the failing PCI slot from the information in the firmware maintained PCI resource allocation map includes identifying the failing PCI slot from an address associated with a base address register when the logged error address falls within a known address size range for the address associated that base address register.

5. The method of claim 4 wherein the step of identifying the failing PCI slot further includes identifying the failing PCI slot as unknown when the logged error address falls after a known address size range of an address associated with that base address register preceding the logged error address.

6. The method of claim 4 wherein the step of identifying the failing PCI slot further includes identifying the failing PCI slot from the address associated with that base address register preceding the logged error address when the logged error address where the address the size range for that preceding BAR is unknown.

7. The method of claim 6 wherein the step of identifying the failing PCI slot further includes identifying the failing PCI slot from the address associated with that base address register preceding the logged error address when the address the size for the address associated with that preceding BAR is unknown.

8. The method of claim 7 wherein upon the occurrence of a hot plug operation for a PCI slot, a hot plug flag associated with that PCI slot is set and upon the host bridge logging an error address, invalidating the firmware maintained PCI resource allocation map entries associated with each PCI slot having its hot plug flag set and clearing those hot plug flags.

9. The method of claim 8 and further including upon the occurrence of firmware being called to execute a PCI configuration space transaction, invalidating the firmware maintained PCI resource allocation map entries associated with each PCI slot having its associated hot plug flag set and clearing those hot plug flags.

10. In a computer having a peripheral component interconnect (PCI) system having a host bridge coupling a plurality of PCI slots of a PCI bus to a processor, the computer accessing base address registers with firmware, a method of identifying a failing PCI slot, comprising the steps of:
(a) creating a firmware maintained PCI resource allocation map in which addresses for PCI slots associated with the base address registers and sizes of address ranges for these addresses are mapped;
(b) upon the occurrence of a hot plug operation for a PCI slot, setting a hot plug flag associated with that PCI slot;
(c) upon the occurrence of at least one of the firmware being called to execute a PCI configuration space transaction and the host bridge logging an error address, invalidating the firmware maintained PCI resource allocation map entries for each PCI slot having its hot flag set; and
(d) upon the host bridge logging an error address due to a failing PCI slot, identifying the failing PCI slot from an address associated with a base address register when the logged error address falls within a known address size range for the address associated that base address register and identifying the failing PCI slot as unknown when the logged error address falls after a known address size range of an address associated with that base address register preceding the logged error address.

11. The method of claim 10 wherein the step of identifying the failing PCI slot further includes identifying the failing PCI slot from the address associated with that base address register preceding the logged error address when the address the size range for the address associated with that preceding BAR is unknown.

12. In a computer having a peripheral component interconnect (PCI) system having a PCI to PCI bridge coupling a plurality of PCI slots of a PCI bus to a processor, the computer accessing base address registers with firmware, a method of identifying a failing PCI slot below the PCI to PCI bridge, comprising the steps of:
(a) creating a firmware maintained PCI resource allocation map in which addresses for PCI slots associated with the base address registers and sizes of address ranges for these addresses are mapped;
(b) upon the occurrence of a hot plug operation for a PCI slot, setting a hot plug flag associated with that PCI slot;
(c) upon the occurrence of at least one of the firmware being called to execute a PCI configuration space transaction and the PCI to PCI bridge logging an error address, invalidating the firmware maintained PCI resource allocation map entries for each PCI slot having its hot flag set; and
(d) upon the PCI to PCI bridge logging an error address due to a failing PCI slot, identifying the failing PCI slot from an address associated with a base address register when the logged error address falls within a known address size range for the address associated that base address register and identifying the failing PCI slot as unknown when the logged error address falls after a known address size range of an address associated with that base address register preceding the logged error address.

13. The method of claim 12 wherein the step of identifying the failing PCI slot further includes identifying the failing PCI slot from the address associated with that base address register preceding the logged error address when the address the size range for the address associated with that preceding BAR is unknown.
